(19) United States
(12) Patent Application Publication
(10) Pub. No.: US 2014/0317563 A1
(43) Pub. Date: Oct. 23, 2014

(54) GENERATE FIELD MAPPING

(71) Applicant: JOHN O'BYRNE, Santa Clara, CA (US)

(72) Inventor: JOHN O'BYRNE, Santa Clara, CA (US)

(21) Appl. No.: 13/867,129

(22) Filed: Apr. 22, 2013

(51) Int. Cl. G06F 3/0482; G06F 3/0484

(52) U.S. Cl. CPC G06F 3/0482; G06F 3/04847
USPC 715/810

(57) ABSTRACT

In one aspect, source fields in the data format of the source data store are transformed and mapped to a format suitable for the target data store. In the user interface of the mapping application, mapping templates using mapping functions can be defined and generated. Mapping template comprises various restriction conditions to determine compatible source fields from among the source fields in the source data store. Mapping functions in the mapping template enable such automation in determining compatible source fields and applying the mapping function to the determined compatible source fields.

### BACKGROUND

Enterprises are required to manage enormous amount of data residing in heterogeneous data stores. The needs of the enterprises may require migrating data from one data store to another. In the process of migration, data from one data store needs to be transformed to be compatible with the target data store. Typically, this is a manual process where users apply transformation functionality to data in the source data store. This manual effort is cumbersome and time consuming.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating generation of field mappings, according to an embodiment.

FIG. 2 illustrates example tables loaded for view in a mapping application according to one embodiment.

FIG. 3 and FIG. 4 illustrate generation of mapping template in the mapping application, according to one embodiment.

FIG. 5 illustrates applying the generated mapping template to the source fields, according to one embodiment.

FIG. 6 illustrates a user interface displaying the number of mapped source fields, according to one embodiment.

FIG. 7 illustrates a user interface after applying mapping function to the compatible source fields, according to one embodiment.

FIG. 8 illustrates a flow diagram of a method of generating field mapping, according to one embodiment.

FIG. 9 is a block diagram of an exemplary computer system according to one embodiment.

### DETAILED DESCRIPTION

Embodiments of techniques for generating field mapping are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Enterprises manage a large amount of data residing in heterogeneous data stores. Data in a data store may be stored in a variety of data formats. When data from a Source data store needs to be migrated to a target data store, data in the source data store needs to be mapped and/or transformed into a format supported by the target data store. The mapping enables conversion of data from the data format of the source data store to the data format of the target data store. Source data store can have a number of tables, schema, etc., which comprise numerous source data fields of varying data types.

In the mapping step, the source data fields in the data format of the source data store are transformed and mapped to a target data field in a format suitable for the target data store. Typically, a user can manually select the individual source data fields, and type in a function to enable such transformation and mapping. A function associates an input to a corresponding output, according to a rule. A rule in the function may be defined by a formula, program logic, algorithm, etc. The user can manually select the individual source data field and type in the function required to map the source data field to the format compatible with the target data store. This is a time consuming and cumbersome task, where the user is required to repeatedly perform selection of fields and typing of the function for a plurality of source data fields.

Embodiments described herein automate determining and applying the function. Mapping functions in the mapping applications enable such automation in determining and applying the function to the source data fields. The mapping application can be built by implementing the required logic to enable such transformation and mapping. In one embodiment, the mapping application may be a software application providing developers or customers the facility to work with the underlying database, a web application, a desktop application, a software-as-a-service application and the like.

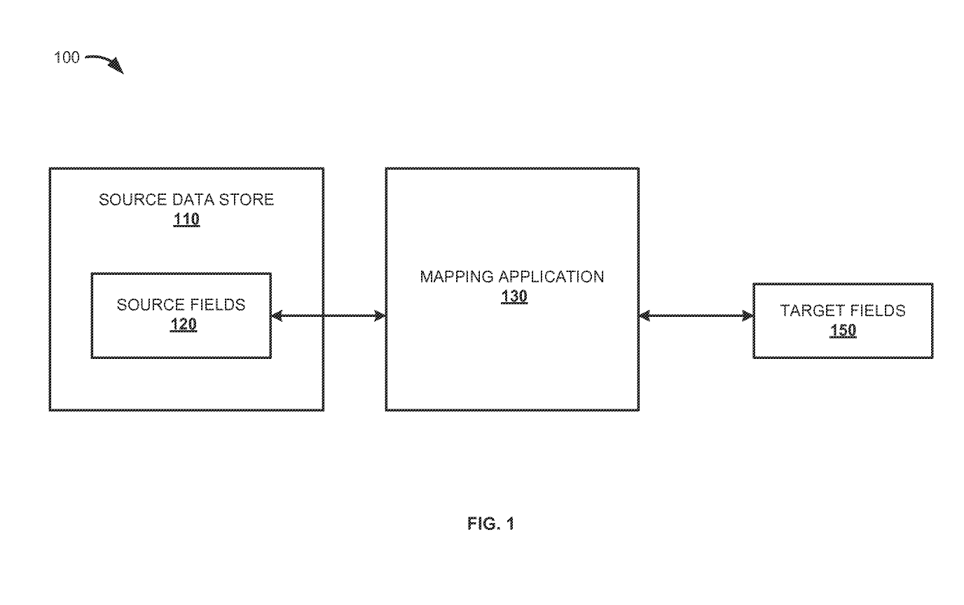

FIG. 1 is a block diagram illustrating generation of field mappings, according to an embodiment. Data store is a data repository and can be of varying types. Examples of data stores include database, flat files, relational database like MySQL, object-oriented database, operational data stores, distributed data stores. Typically, each data store stores data in a format supported by that data store. In one embodiment, an enterprise stores data in a source data store 110. The source data store 110 has a number of tables, schemas, etc. Each table in the source data store 110 has numerous source fields 120, of varying data types. For example, ‘Product’ table may have fields such as ‘Product name’ of character data type, ‘Price’ of integer data type, ‘Weight’ of double data type, etc. The source fields 120 in a source data format is transformed and mapped by a mapping application 130, to target fields 150 in a target data format. For example, the source field ‘Product name’ of character data type can be mapped to a function ‘Remove left spaces’ to remove left spaces in the product name, and generate the target field ‘Product name’ that is supported by the corresponding target data store.

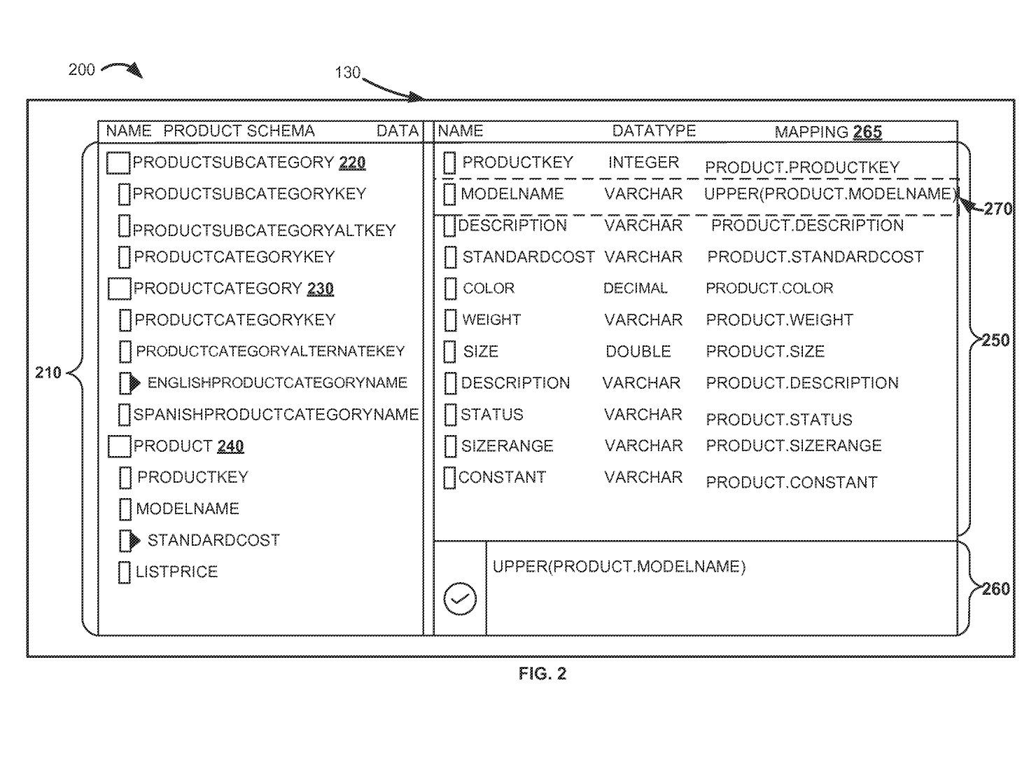

Input schemas and the associated tables required for mapping can be selected and loaded in the mapping application 130. In one embodiment, an exemplary set of input tables 210 such as ‘Product subcategory’ 220, ‘Product category’ 230 and ‘Product’ 240 in the source data store 110 can be loaded for view in the mapping application 130, as shown in 200 of FIG. 2. The ‘Product subcategory’ 220 table comprising fields such as ‘ProductSubcategoryKey’, ‘ProductCategoryKey’, etc., is displayed in the user interface in the mapping application 130. Similarly, ‘Product’ 240 table comprising fields such as ‘ProductKey’, ‘ModelName’, ‘Weight’, etc., is displayed in the user interface in the mapping application 130.

The source field names, data types and mappings of the tables ‘Product subcategory’ 220, ‘Product category’ 230 and ‘Product’ 240 are shown in window 250. ‘ModelName’ field of varchar data type is shown in window 250. ‘Varchar’ data type also referred to as variable character field, is a set of character data bound by the size supported by the respective database or data store. For example, initially mapping 265 column for the ‘ModelName’ source filed contains the original value as ‘ProductModelName’ as shown in 270. If a mapping function ‘Upper’ to transform this source fieldname ‘ModelName’ to upper case is to be applied, user has to select the source fieldname ‘ModelName’ and, in the window 260, the function ‘Upper’ along with the ‘ModelName’ field is typed as Upper(Product.ModelName). When such mapping function is to be applied to a number of fields, a mapping template can be generated with the function, and applied to the number of source fields automatically, as will be described below.

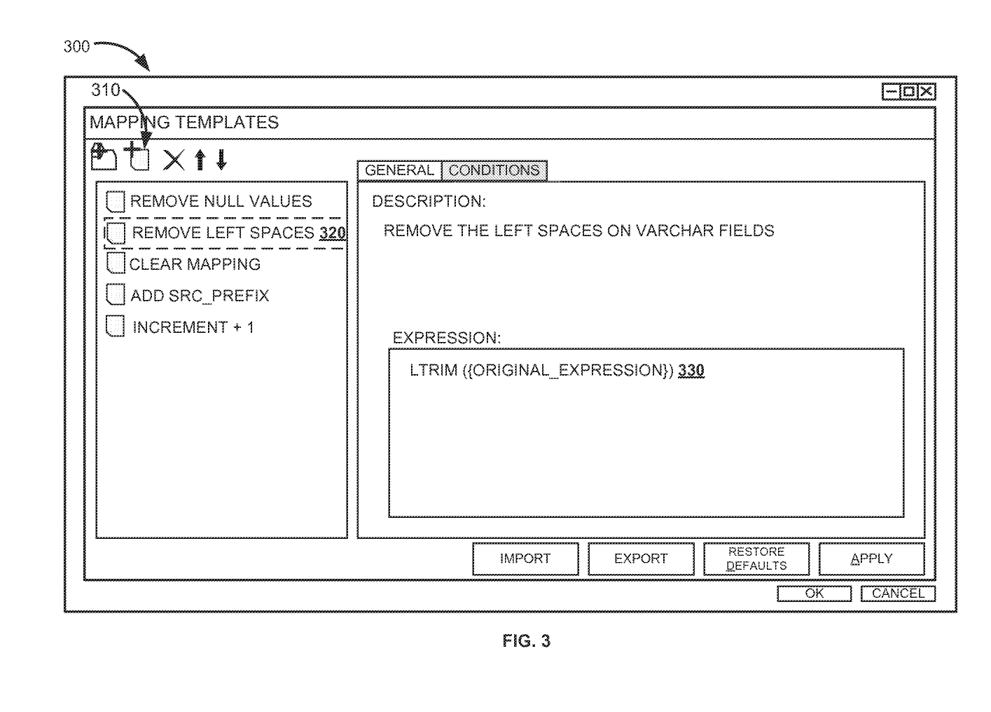

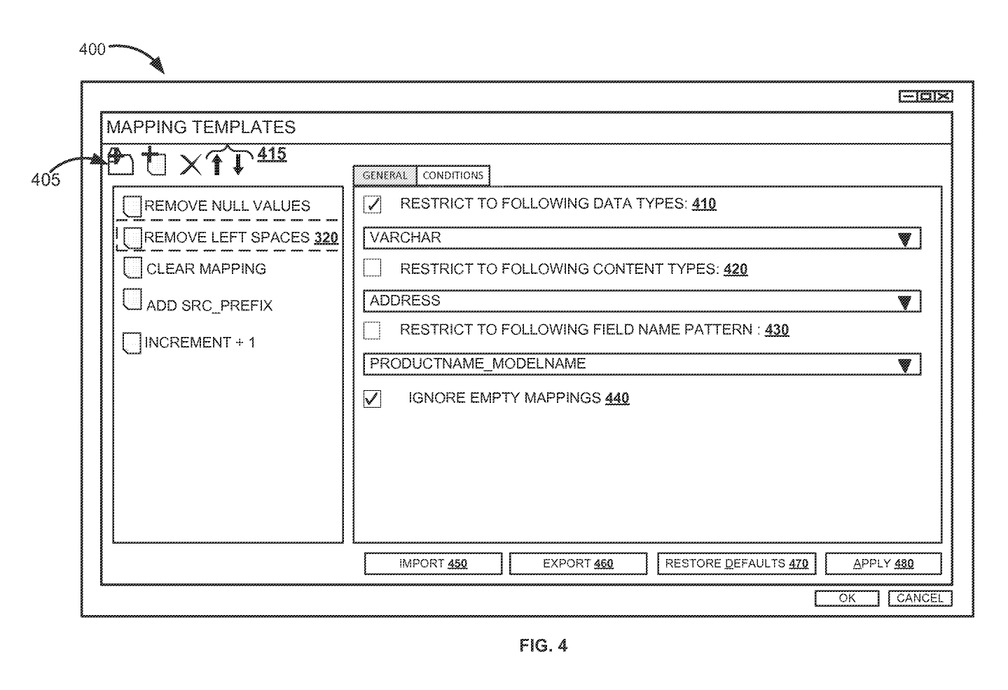

FIG. 3 and FIG. 4 illustrate generation of mapping template in the mapping application, according to one embodiment. In the user interface 300 of the mapping application, options required to generate mapping templates are provided. For example, to generate a mapping template for removing left spaces, user can click on an icon 310 associated to new mapping template, and enter the name of the mapping template as ‘Remove left spaces’ 320. Description of the mapping template is provided in the description section of the general tab. Mapping template for ‘Remove left spaces’ 320 is defined as an expression ‘ltrim ({original_expression})’ 330 in the expression section of the general tab. Here ‘ltrim’ is the mapping function that performs removing the left spaces on the ‘original_expression’. ‘Original_expression’ is a placeholder which gets substituted by the source fields such as ‘ProductKey’, ‘ModelName’, ‘weight’, etc., as ltrim(Product.Productkey), ltrim(Product.ModelName) and ltrim(Product.weight) respectively.

In one embodiment, mapping expression can be of various types such as direct mapping, constant mapping and complex mapping. In direct mapping, the target field points directly to the source field with no transformation. For example, a ‘source address field’ can be directly mapped to the ‘target address field’, and there is no transformation involved here. In constant mapping, a hard coded value is assigned to the source field to generate the target field. For example, ‘gender’ source field can be assigned constant values such as ‘Male’ or ‘Female’. Assigning constant value to the source field generates the target field. In complex mapping, any expression using a function can be used to generate target field. For example, the expression such as upper (Product.colour) has the function upper, to transform the source color field to upper case characters and map it to the target color field. In complex mapping, any expression using any function along with multiple input fields can be used to generate target fields. For example, the expression “Product.color∥‘-’∥Product.size∥‘-’∥Product.ModelName” combines the source fields color, size and modelname to map it to the target Product.Item field. The notation ∥‘-’∥ represents a string concatenation operator, where product.color and product.size are the strings concatenated with a hyphen in between them. In one embodiment, the expression can be an expression macro, where an expression macro may comprise a function or a rule or pattern that specifies how certain source field inputs are mapped to target fields.

In the user interface 400 of FIG. 4, the conditions to restrict applying the mapping template to compatible source fields can be specified. In the conditions tab, restriction conditions corresponding to the ‘Remove left spaces’ 320 napping template can be specified. Restriction conditions, enable applying the mapping templates to the compatible source fields from among the selected source fields. Source fields satisfying the restriction conditions qualify as compatible source fields. individual restriction conditions such as ‘Restrict to following data types’ 410, ‘Restrict to following content types’ 420, and ‘Restrict to following field name patterns’ 430 can be specified for the ‘Remove left spaces’ 320 mapping template. In the ‘Restrict to following data types’ 410, user can select the data types such as ‘varchar’ and ‘double’ from the list of available data types. Accordingly, the ‘Remove left spaces’ 320 mapping template is restricted and applied to the compatible source fields having ‘varchar’ and ‘double’ data types,

In the ‘Restrict to following content types’ 420, user can select the content types such as ‘address’ and ‘date’ from the list of available content types. Accordingly, the ‘Remove left spaces’ 320 mapping template is restricted and applied to the compatible source fields having ‘address’ and ‘date’ content types. In the ‘Restrict to following field name pattern’ 430, user can specify a pattern such as “ProductName_Modelname”. Accordingly, the ‘Remove left spaces’ 320 mapping template is restricted and applied to the compatible fields matching the pattern. ‘Ignore empty mappings’ 440, can be used to restrict applying ‘Remove left spaces’ 320 mapping template to non-empty fields. After specifying the restriction conditions user can click on ‘Apply’ 480 option to generate ‘Remove left spaces’ 320 mapping template.

In one embodiment, when individual restriction conditions such as ‘Restrict to following data types’ 410, ‘Restrict to following content types’ 420 and ‘Restrict to following field name pattern’ 430 are specified, the source fields satisfying all the individual restriction conditions are determined as compatible source fields. In one embodiment, one or more of the individual restriction conditions can be specified. The compatible source fields are determined based on the number of individual restriction conditions specified. In one embodiment, custom or user defined restriction conditions can be defined. Custom restriction conditions can be defined on any type of entity such as data, data format, rule, function, pattern and the like.

In one embodiment, users can share the generated mapping template using import and export options. Export 460 option, can be used to export the generated ‘Remove left spaces’ 320 mapping template to any file format specified by the user. For example, if ‘User A’ wants to share the ‘Remove left spaces’ 320 mapping template to ‘User B’. ‘User A’ can export the ‘Remove left spaces’ 320 mapping template to an XML file and store it in a storage location. The stored XML file can be shared with ‘User B’ using any of the communication mechanisms such as email, FTP file transfer, etc. ‘User B’ can import 450 this XML file directly or by changing it to an appropriate format, to the mapping application and use it. ‘Restore defaults’ 470 option, allows user to specify the default expression and default restriction conditions to be used in cases where the user does not specify an explicit mapping template. In one embodiment, the generated mapping templates can be organized in folders using the ‘new folder’ 405 option. Generated mapping templates can be arranged or rearranged by moving the generated mapping templates up and down using icons 415.

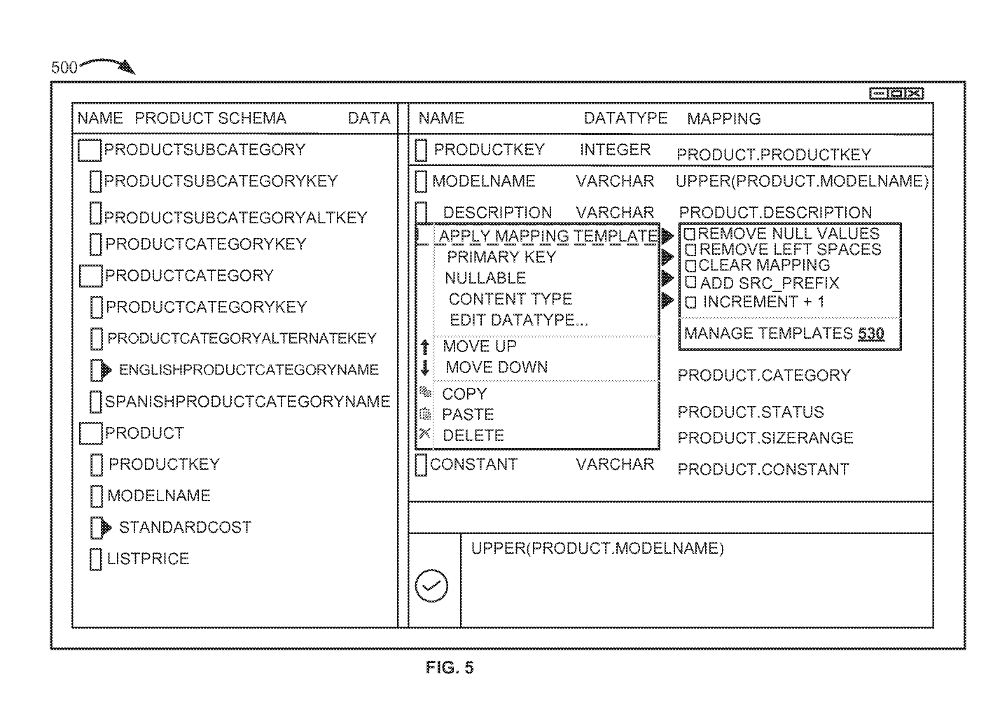

FIG. 5 illustrates applying the generated mapping template to the source fields, according to one embodiment. In one embodiment, user can select some source fields or user can select all the source fields to apply the generated mapping template, Upon selection of the source fields, list of mapping templates available are displayed in the user interface as a context menu. Context menu is a menu that appears in the user interface based on user interaction such as a mouse click, button press, etc. The mapping template that is required to be applied is selected from the list of mapping templates available. Based on the restriction conditions specified in the selected mapping template, compatible source fields satisfying the restriction conditions are determined. The mapping template is applied to the determined compatible source fields, and the remaining non-compatible source fields are ignored.

In one embodiment, upon selection of the source fields, along with the display of the list of mapping templates, an option to ‘manage templates’ 530 is displayed. ‘Manage templates’ 530, provides users with the option to add new template, edit existing template, delete template and few other controls to modify and manage the mapping templates. In one embodiment, after selection of the source fields, user can choose to click on ‘manage template’ 530 and either create a new mapping template and apply it, or edit any existing mapping template to apply on the selected source fields.

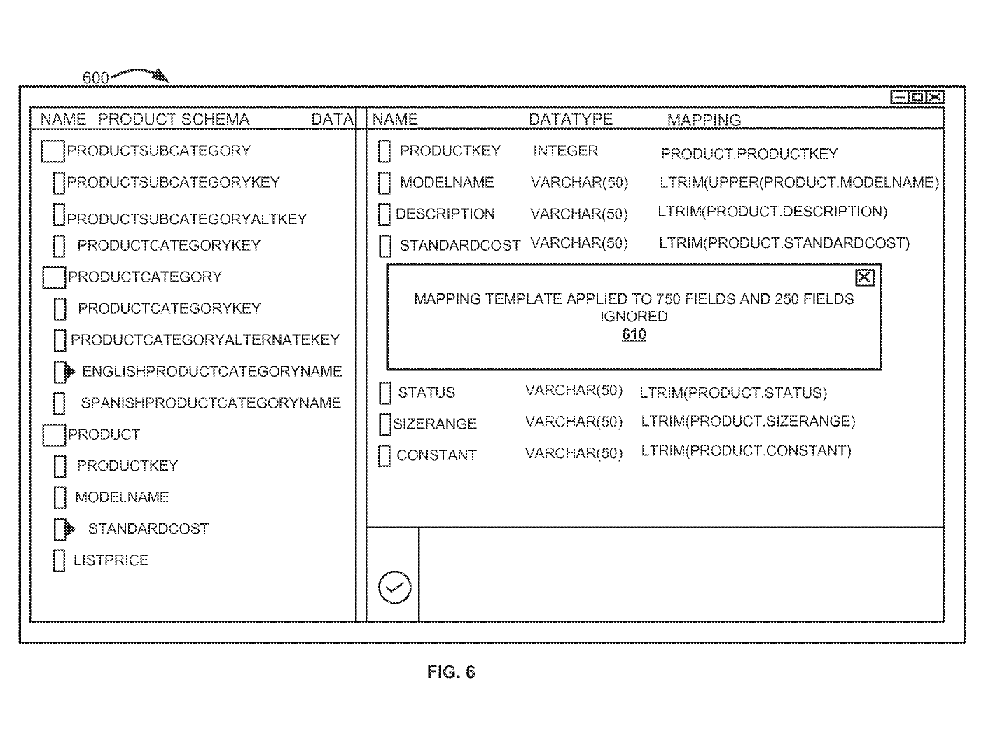

An example embodiment illustrating applying the generated mapping template to the source fields is explained below. For example, the user selects one thousand source fields and selects the ‘Remove left spaces’ 320 mapping template for applying on the source fields. Compatible source fields, satisfying the individual restriction conditions such as ‘Restrict to following data types’ 410, ‘Restrict to following content types’ 420 and ‘Restrict to following field name patterns’ 430 are determined. Among the one thousand source fields, seven hundred and fifty source fields are determined to be compatible source fields. ‘Remove left spaces’ 320 mapping template is applied to the seven hundred and fifty compatible source fields. After applying the mapping template, a pop-up window appears in the user interface as shown in FIG. 6, the pop-up window indicates the number of source fields to which the mapping template was applied, and the number of source fields ignored. The pop-up window 610, displayed in the user interface indicates that ‘Mapping template applied to 750 fields and 250 fields ignored’. That is, show a number of mapped source fields and a number of ignored source fields. In various embodiments, information on the number of mapped source fields and the number of ignored source fields displayed in the user interface. An example of displaying information is presenting in a pie chart.

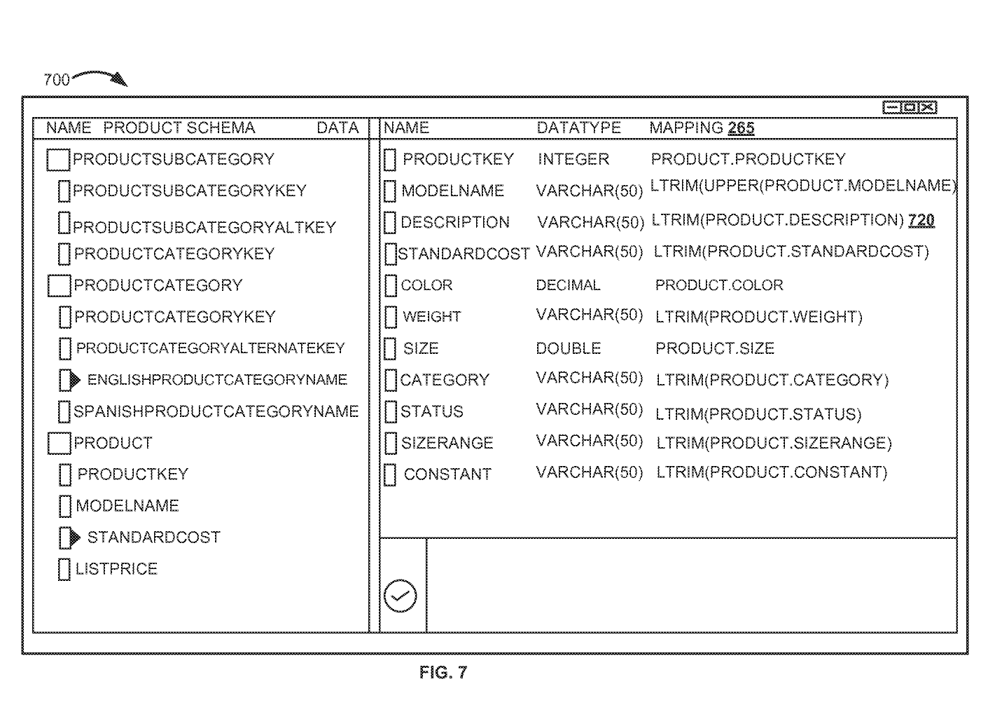

FIG. 7 illustrates a user interface after applying the mapping function to the compatible source fields. After applying the ‘Remove left spaces’ 320 mapping template to the seven hundred and fifty compatible source fields, the mapping column reflects the substituted mapping function based on the expression defined in the mapping template. For example, source field ‘Product Description’ contains the original value ‘Product. Description’ in the mapping column. The ‘Product Description’ source field is determined to be a compatible field, since it satisfies all the restriction conditions of the ‘Remove left spaces’ 320 mapping template. After applying the ‘Remove left spaces’ 320 mapping template, the mapping 265 column reflects the substituted mapping function as “ltrim(Product.Description)” 720. Similarly, the remaining compatible source fields are determined and the ‘Remove left spaces’ 320 mapping template is applied. The mapping column for the remaining compatible source fields is updated and it reflects the substituted mapping function.

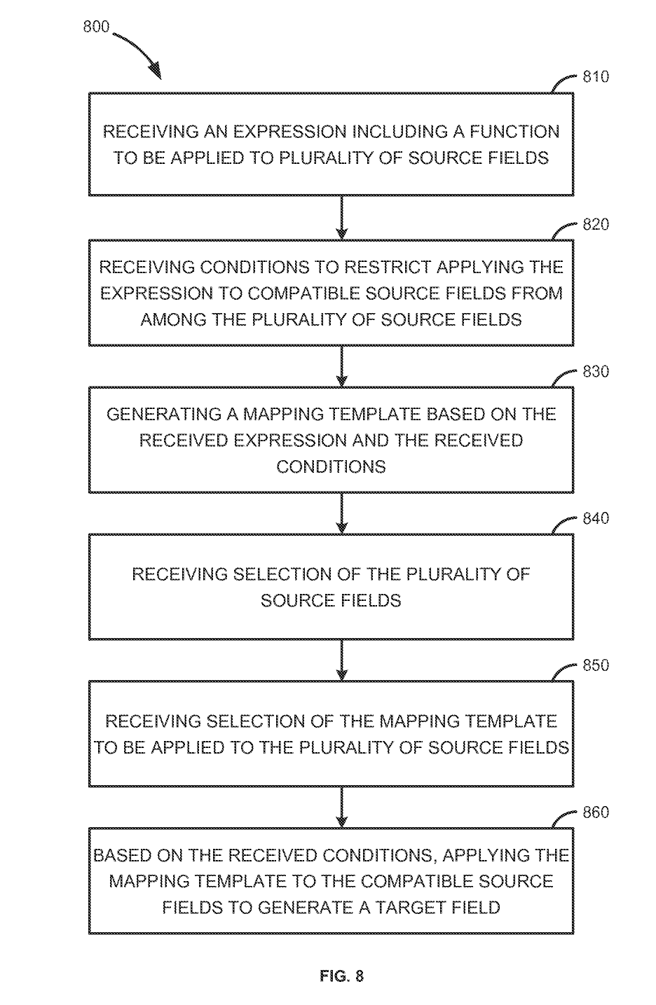

FIG. 8 illustrates a flow diagram 800 of a method of generating field mapping, according to one embodiment. In the user interface of the mapping application, options required to generate mapping templates are provided. Based on the conditions specified in the mapping template, compatible source fields are determined Generated mapping template can be applied to the determined compatible source fields to generate target fields. At 810, the mapping application receives an expression including the function to be applied to the source fields. At 820, the mapping application receives conditions to restrict applying the expression to compatible source fields from among the selected source fields. Based on the received conditions, compatible source fields are determined from among the selected source fields. At 830, the mapping template is generated based on the received expression and the received conditions. At 840, selection of the source fields is received and, at 850, selection of the mapping template to be applied to the selected source fields is received. At 860, based on the received conditions, the mapping template is applied to the compatible source fields to generate target fields.

Many environments often contain many more applications and utilities, both in number and type, depending on the purpose for which the environment is designed. In one example embodiment, the mapping application can be used in an ETL (Extract, transformation and loading) scenario in the data warehouse. ETL involves extracting, transforming, and loading data from heterogeneous sources into the target database or data warehouse. Data is extracted or read from the source database to a staging area. Staging area is an intermediate storage area between the source database and the data warehouse (DW). In this intermediate area, transformation of the source data takes place. In transformation, the extracted source data is converted from the source data form to a data form required by the target data warehouse. Transformation occurs by using rules or lookup tables or by combining the data with other data. The mapping application can be used at this stage, where data transformation takes place. Mapping functions can be defined as expressions with mapping functions to transform source fields to target fields. Target fields thus transformed can be loaded to the data warehouse for use by end-users.

In one example embodiment, the mapping application can be used in replicating database. Replication is sharing or copying information, to ensure consistency, reliability and fault-tolerance. In database replication, same data is stored on multiple storage devices. For example, a ‘database X’ which has one million source fields can be replicated to another ‘database Y’ using the mapping application. The source fields from ‘database X’ can be mapped to ‘database Y’ using the mapping application. Mapping templates can be defined as expressions with mapping functions, to transform the one million source fields from ‘database X’ to ‘database Y’. Although ETL and database replication environments are discussed above, the embodiments described herein can be used in various other environments such as, but not limited to, services based applications, data modeling tools.

The various embodiments described above have a number of advantages. For example, if there is a customer requirement to transform and map two hundred source fields from ‘database Z’ to another ‘database A’. In the manual approach, it takes approximately five seconds per source field, which amount to 1000 seconds for the entire two hundred source fields to be transformed and mapped to target fields in ‘database A’. While using the mapping application, the two hundred source fields are selected and the required mapping template is selected and applied. The two hundred source fields are transformed and mapped in five seconds. In a scenario where more than one mapping template is required to be applied, the manual approach may require 2000 seconds or more, whereas using the mapping template requires ten to twenty seconds for transforming and mapping the same number of records. Thus, this approach eliminates the substantial time spent using manual approach for transformation and mapping of source fields to target fields. Therefore, performance of mapping, using the mapping template in the mapping application, is significantly improved over the manual approach. The user interface of the mapping application provides ease of use in defining complex expressions.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

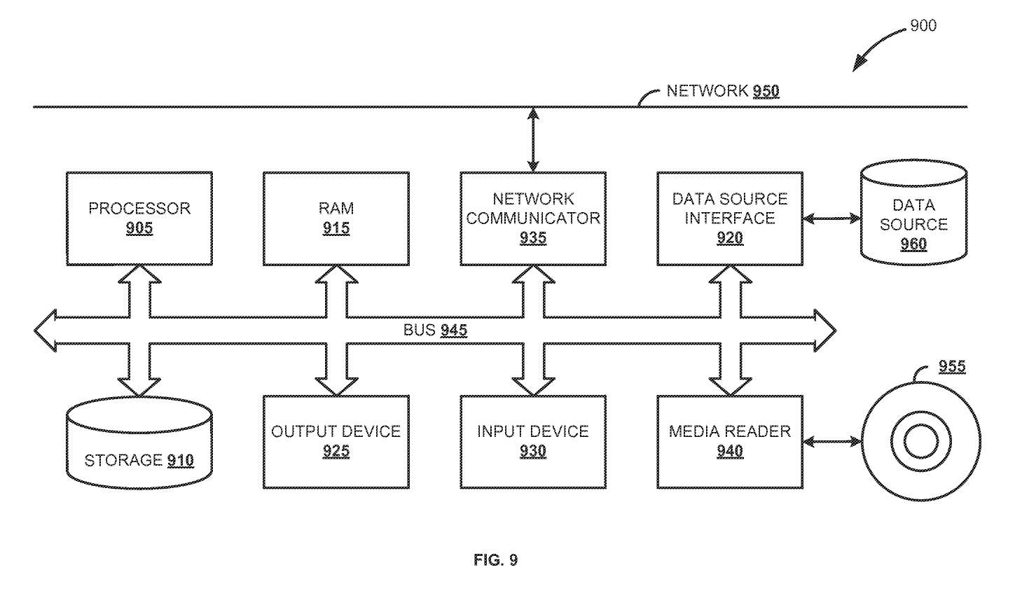

FIG. 9 is a block diagram of an exemplary computer system 900. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and put devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional. (e.g., OLAP), object oriented databases, and the like. Further data sources include tabular data (e.g., spreadsheets, delimited text files), data tagged with a mark-up language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a computer readable storage medium to store instructions, which when executed by a computer, cause the computer to:
receive an expression including a function to be applied to a plurality at source fields of a source data store;
receive conditions to restrict application of the expression to compatible source fields of the plurality of source fields;
generate a mapping template based on the received expression and the received conditions;
receive selection of one or more source fields of the plurality of source fields;
receive selection of the mapping template to be applied to the selected one or more source fields; and
apply the mapping template to the compatible source fields to generate a target field.

2. The article of manufacture of claim 1, further comprising instructions which when executed by the computer further causes the computer to:
display the list of generated mapping templates in a context menu in a user interface.

3. The article of manufacture of claim 1, further comprising instructions which when executed by the computer further causes the computer to:
upon applying the mapping template to the compatible source fields, display information on number of mapped source fields and number of ignored source fields in the user interface.

4. The article of manufacture of claim 1, wherein the received conditions comprise one or more of restriction to a data type, restriction to a content type and restriction to a field name pattern.

5. The article of manufacture of claim 1, wherein the expression is an expression macro comprising functions to execute on the source field.

6. The article of manufacture of claim 1, further comprising instructions which when executed by the computer further causes the computer to:
upon applying the mapping template to the compatible source fields, display the list of target fields along with the expression applied.

7. The article of manufacture of claim 2, further comprising instructions which when executed by the computer further causes the computer to:
display an option to manage template along with the list of generated mapping templates in the context menu in the user interface, wherein the option to manage template provides users with options to add template, edit template and delete template.

8. A computer implemented method for generating field mapping, the method comprising:
receiving an expression including a function to be applied o a plurality of source fields of a source data store:
receiving conditions to restrict application of the expression to compatible source fields of the plurality of source fields;
generating a mapping template based on the received expression and the received conditions;
receiving selection of one or more source fields of the plurality of source fields;
receiving selection of the mapping template to be applied to the selected one or more source fields; and
applying the mapping template to the compatible source fields to generate a target field.

9. The method of claim 8, further comprising:
display the list of generated mapping templates in a context menu in a user interface.

10. The method of claim 8, further comprising:
upon applying the mapping template to the compatible source fields, display information on number of mapped source fields and number of ignored source fields in the user interface.

11. The method of claim 8, wherein the received conditions comprise one or more of restriction to a data type, restriction to a content type and restriction to a field name pattern.

12. The method of claim 8, wherein the expression is an expression macro comprising functions to execute on the source field.

13. The method of claim 8, further comprising:
upon applying the mapping template to the compatible source fields, display the list of target fields along with the expression applied.

14. The method of claim 9, further comprising:
display an option to manage template along with the list of generated mapping templates in the context menu in the user interface, wherein the option to manage template provides users with options to add template, edit template and delete template.

15. A computer system for generating field mapping, comprising:
a computer memory to store program code; and
a processor to execute the program code to:
receive an expression including a function to be applied to a plurality of source fields of a source data store;
receive conditions to restrict applying the expression to compatible source fields of the plurality of source fields;
generate a mapping template based on the received expression and the received conditions;
receive selection of one or more source fields of the plurality of source fields:
receive selection of the mapping template to be applied to the selected one or more source fields; and
apply the mapping template to the compatible source fields to generate a target field.

16. The system of claim 15, wherein the processor further executes the program code to:
display a list of generated mapping templates in a context menu in a user interface; and
display an option to manage template along with the list of generated mapping templates in the context menu in the user interface, wherein the option to manage template provides users with options to add template, edit template and delete template.

17. The system of claim 15, wherein the processor further executes the program code to:
upon applying the mapping template to the compatible source fields, display information on number of mapped source fields and number of ignored source fields in the user interface.

18. The system of claim 15, wherein the received conditions comprise one or more of restriction to a data type, restriction to a content type and restriction to a field name pattern.

19. The system of claim 15, wherein the expression is an expression macro comprising functions to execute on the source field.

20. The system of claim 15, wherein the processor further executes the program code to:
upon applying the mapping template to the compatible source fields, display the list of target fields along with the expression applied.
